(19) United States
(12) Patent Application Publication
(10) Pub. No.: US 2025/0168694 A1
(43) Pub. Date: May 22, 2025

(54) METHOD AND NETWORK APPARATUS FOR DETERMINING AN OPTIMAL UPLINK SLOT DIVISION IN A TELECOMMUNICATION NETWORK

(71) Applicant: SAMSUNG ELECTRONICS CO. LTD., Suwon-si (KR)

(72) Inventors: Gaurav SINGH, Bangalore (IN); Allen Job, Bangalore (IN); Vikash Kumar, Bangalore (IN); Dheeraj Kumar, Bangalore (IN)

(21) Appl. No.: 18/765,875

(22) Filed: Jul. 8, 2024

Related U.S. Application Data
(63) Continuation of application No. PCT/KR2024/009234, filed on Jul. 1, 2024.

(30) Foreign Application Priority Data
Nov. 16, 2023 (IN) 202341078004

(51) Int. Cl. H04W 28/02; H04W 72/0446; H04W 72/1268; H04W 72/56

(52) U.S. Cl. CPC H04W 28/0278; H04W 72/0446; H04W 72/1268; H04W 72/56

(57) ABSTRACT

An embodiment herein provides a method and network apparatus for determining an optimal uplink slot division in telecommunication network. The method comprises: detecting, by a network apparatus in telecommunication network, a list of radio bearers associated with plurality of UE; determining, a Buffer Occupancy (BO) of each radio bearer of a list of radio bearers associated with plurality of UE; determining, a BO threshold for each radio bearer from list of radio bearers; classifying, the list of radio bearer into plurality of radio bearer groups based on BO and BO threshold for each of the radio bearer; and determining, the optimal uplink slot division based on the plurality of radio bearer groups.

### CROSS-REFERENCE TO RELATED APPLICATIONS

This application is a continuation of International Application No. PCT/KR2024/009234 designating the United States, filed on Jul. 1, 2024, in the Korean Intellectual Property Receiving Office and claiming priority to Indian Complete Patent Application No. 202341078004, filed on Nov. 16, 2023, in the Indian Patent Office, the disclosures of each of which are incorporated by reference herein in their entireties.

### BACKGROUND

### Field

The disclosure relates to a 5^{th} Generation (5G) network. For example, the disclosure relates to a method and network apparatus for determining an optimal uplink slot division in a telecommunication network.

### Description of Related Art

In a 5G network, plurality of packets are received at a base station (gNodeB) for transmission of the plurality of packets to destination. The plurality of packets can be transmitted by at least one user equipment (UE) associated with the base station. The base station (gNodeB) receives plurality of packets from plurality of UE and further queues the received packets for further transmission. The base station in a 5G network uses one or more scheduling techniques for scheduling the transmission of the queued packets to a destination. In an existing art, the base station in the 5G network, schedules the plurality received packets based on QoS parameters and network conditions for the transmission. In various embodiments, the base station can perform at least one dynamic scheduling or static scheduling.

The static scheduling is fixed before transmission based on the information available at that time. Whereas the dynamic scheduling is performed during runtime.

The scheduling of candidates at base station is limited by serving beams for individual candidates. For example, consider the maximum number of serving beams supported per symbol is N. Further, the base station allocates the resources to the candidates by considering 1 slot (14 symbols) as single entity for resource allocation.

Further, in a scenario consider when a set of scheduling candidates are decided to be scheduled, the base station will allocate an entire 1 slot (14 symbols) to a single candidate, since the serving beam of any other candidate is not same as the serving beam of the scheduled candidate. However, assigning the entire single slot for a single candidate leads to a resource wastage when the scheduled candidate has low buffer occupancy. Thus, there is a need for an improved method of scheduling the uplink transmission in the 5G network.

### SUMMARY

Embodiments of the disclosure provide an optimal method of scheduling an uplink transmission in 5G network.

Embodiments of the disclosure determine whether the slot divisions are required during the uplink transmission in the 5G network

Embodiments of the disclosure determine optimal number of divisions to be made in a slot for the uplink transmission in the 5G network.

Accordingly, an example embodiment provides a method of determining an optimal uplink slot division in a telecommunication network. The method includes: detecting, by a network apparatus in the telecommunication network a list of radio bearers associated with plurality of user equipment (UE) available in the telecommunication network; determining a Buffer Occupancy (BO) of each radio bearer of the list of radio bearers associated with the plurality of UE; determining a plurality of BO threshold for each radio bearer from the list of radio bearers; classifying the list of radio bearers into a plurality of radio bearer groups based on the plurality of BO threshold for each radio bearer from the list of radio bearers and the BO of each radio bearer from the list of radio bearers; and determining optimal uplink slot division based on the plurality of radio bearer groups.

In an example embodiment, determining the optimal uplink slot division for scheduling in the telecommunication network based on the plurality of radio bearer groups comprises: selecting at least one radio bearer group having highest priority radio bearers from the plurality of radio bearer groups, wherein the highest priority radio bearers have a maximum BO; detecting a radio bearer group among the at least one selected radio bearer group having a lowest number of divisions possible in a slot; and determining the optimal slot division by allocating the lowest number of divisions as optimal division for a current slot.

In an example embodiment determining, by a server associated with the network apparatus, the optimal uplink slot division in a telecommunication network comprises: determining whether the uplink (UL) physical resource block (PRB) usage metric meets a UL PRB metric threshold; performing one of determining a plurality of second scheduling parameters associated with at least one UE when the UL PRB usage metric meets the UL PRB usage metric threshold, inputting the plurality of second scheduling parameters of the at least one machine learning (ML) model; and determining, by the ML model an optimal uplink slot division in telecommunication network based on plurality of second scheduling parameters.

In an example embodiment, the plurality of first scheduling parameters comprises: at least one of the BO of each radio bearer from the list of radio bearers, a Modulation and Coding scheme (MCS) of the at least one UE, bandwidth parts of the (BWP) of the at least one UE, a minimum symbol length after physical uplink shared channel (PUSCH) symbols has been classified into specific parts for the at least one UE, and a uplink layer count of the at least one UE.

In an example embodiment, the plurality of second scheduling parameters comprises: at least one of the BO of each radio bearer from the list of radio bearers, a Modulation and Coding scheme (MCS) of the at least one UE, bandwidth parts of the (BWP) of the at least one UE, a minimum symbol length after PUSCH symbols has been classified into specific parts for the at least one UE, a uplink layer count of the at least one UE, BO size of each radio bearer from list of radio bearers, frequency of a serving beam of each radio bearer from a list of radio bearers, and a multi-label encoded multi user multiple input-multiple output (MU-MIMO) pairing data of the radio bearers.

In an example embodiment the MCS of the at least one UE corresponds to the list of radio bearers and includes modulation order consideration, and wherein the uplink layer count of the at least one UE corresponds to the list of radio bearers.

In an example embodiment, determining the BO of each radio bearer of the list of radio bearers associated with the at least one UE comprises: receiving a buffer status report by the UE, wherein the buffer status report includes amount of data available at each radio bearer of the list of radio bearers associated with the UE for uplink transmission; and determining a buffer occupancy of each radio bearer of the list of radio bearers associated with the at least one UE based on the buffer status report of the UE.

In an example embodiment, classifying the list of radio bearers into a plurality of radio bearer groups based on the BO threshold for each radio bearer from the list of radio bearers and the BO of each radio bearer from the list of radio bearers comprises: determining the plurality of BO thresholds for each radio bearer of the list of radio bearers associated with plurality of UE based on plurality of first scheduling parameters, and transmission capability of plurality of UE on current channel conditions; grouping each of the radio bearers of the list of the radio bearers associated with the plurality of UE by comparing the BO of each of the radio bearers of list of radio bearers UE with the plurality of BO threshold of each of the radio bearer of list of radio bearers associated with the plurality of UEs, wherein at least one group comprises at least one radio bearer having a smallest BO threshold among the plurality BO thresholds, such that the BO threshold is greater than or equal to the BO of the UE.

In an example embodiment, determining the UL PRB usage metric for at least one machine learning model comprises: determining a number of uplink slots for which uplink scheduling has been performed; determining whether the number of slots utilized for upper link scheduling has exceeded a specified threshold value; and transmitting the number of slots utilized for uplink scheduling, based on the number of slots utilized for uplink scheduling being greater than the specified threshold for performing the optimal uplink slot division using at least one plurality of first scheduling parameters or plurality of second scheduling parameters.

Accordingly, an example embodiment herein provides a network apparatus for determining an optimal uplink slot division in a telecommunication network. The network apparatus includes: a memory, at least one processor, comprising processing circuitry, and a slot scheduler communicatively coupled to the memory and at least one processor. The slot scheduler of the network apparatus is configured to: detect a list of radio bearers associated with at least one UE available in the telecommunication network; determine a Buffer Occupancy (BO) of each radio bearer of the list of radio bearers associated with the at least one UE; determine a BO threshold for each radio bearer from the list of radio bearers; classify the list of radio bearers into a plurality of radio bearer groups based on the BO threshold for each radio bearer from the list of radio bearers and the BO of each radio bearer from the list of radio bearers; and determine optimal uplink slot division based on the plurality of radio bearer groups.

These and other aspects of the various example embodiments herein will be better appreciated and understood when considered in conjunction with the following description and the accompanying drawings. It should be understood, however, that the following descriptions, while indicating example embodiments and various specific details thereof, are given by way of illustration and not of limitation. Many changes and modifications may be made within the scope of the disclosure herein without departing from the spirit thereof, and the embodiments herein include all such modifications.

### BRIEF DESCRIPTION OF THE DRAWINGS

In the accompanying drawings, like reference letters indicate corresponding parts in the various figures. The above and other aspects, features and advantages of certain embodiments of the present disclosure will be more apparent from the following detailed description, taken in conjunction with the accompanying drawings, in which:

FIG. 1A is a diagram illustrating a representation of full Uplink (UL) slot scheduling, according to the prior art;

FIG. 1B is a diagram illustrating an Uplink slot layout during full UL slot scheduling, according to the prior art;

FIG. 2A is a diagram illustrating a representation of UL mini-slot scheduling, according to the prior art;

FIG. 2B is a diagram illustrating an Uplink slot layout during mini-UL slot scheduling, according to the prior art;

FIG. 3 is a block diagram illustrating an example configuration of a network apparatus for determining an optimal uplink slot division in a telecommunication network, according to various embodiments;

FIG. 4A is a diagram illustrating optimal Uplink (UL) mini slot scheduling, according to various embodiments;

FIG. 4B is a diagram illustrating an example Uplink slot layout during mini-UL slot scheduling, according to various embodiments;

FIG. 5A is an example tabular representation of grouping plurality of UEs for determining optimal uplink slot division, according to various embodiments;

FIG. 5B is an example tabular representation of grouping plurality of UEs for determining optimal uplink slot division, according to various embodiments;

FIG. 5C is an example tabular representation of grouping plurality of UEs for determining optimal uplink slot division, according to various embodiments;

FIG. 6 is a flowchart illustrating an example method of determining an optimal uplink slot division in telecommunication network, according to various embodiments;

FIG. 7A is a flowchart illustrating example switching between the ML model and a base model for the determination of optimal uplink slot division, according to various embodiments; and

FIG. 7B is a flowchart illustrating example determination of eligibility of Upper Link Physical Resource Block (UL PRB) usage metrics, according to various embodiments.

### DETAILED DESCRIPTION

The various example embodiments herein and the various features and advantageous details thereof are explained more fully with reference to the non-limiting embodiments that are illustrated in the accompanying drawings and detailed in the following description. Descriptions of well-known components and processing techniques may be omitted so as to not unnecessarily obscure the embodiments herein. The various embodiments described herein are not necessarily mutually exclusive, as various embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced. Accordingly, the examples should not be construed as limiting the scope of the disclosure herein.

Various example embodiments may be described and illustrated in terms of blocks which carry out a described function or functions. These blocks, which may be referred to herein as managers, units, modules, hardware components or the like, may be physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In a 5G network, a gNodeB scheduler is configured to schedule a plurality of candidates received from plurality of User Equipment's (UEs). A radio frame structure in 5G network comprises several numerologies such as radio frame, sub-frame, slots and symbols. The symbol is the smallest unit in the radio frame structure of 5G network. The relationship between numerologies may be as shown below:
14 symbols=1 slot;
1 slot=1 sub-frame;
10 sub-frame=1 radio-frame;

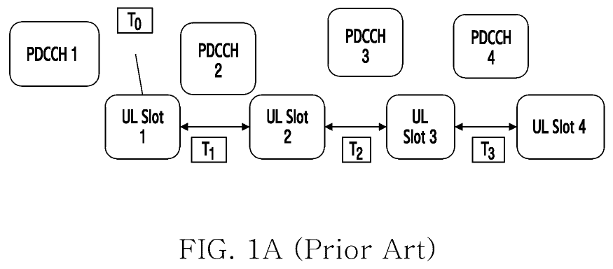

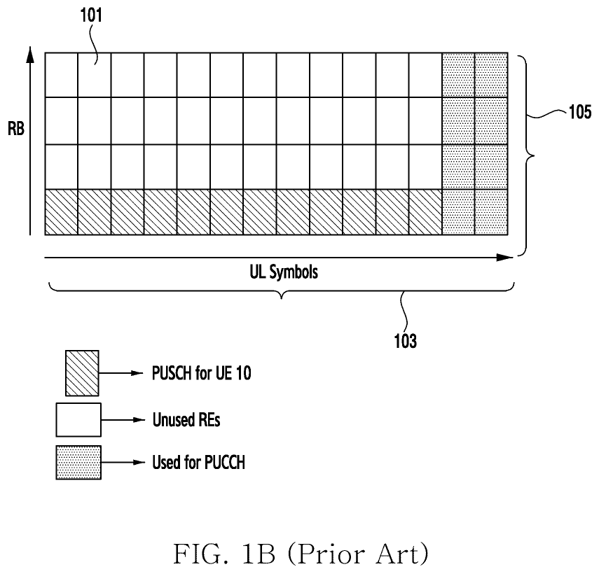

A gNodeB scheduler is configured to schedule the candidates received from the UEs for the data transmission. The gNodeB provides a connectivity between the UE and an Evolved Packet Core (EPC). In an existing system, 5G (5^{th} generation) release 15 of 3GPP allows a data transmission from the User Equipment (UE) which can be scheduled with a grant containing any number of symbols and any number of symbol index. FIG. 1A is a diagram illustrating an example representation of Upper Link (UL) slot scheduling, according to the prior art. Consider a scenario as shown in FIG. 1A the UL slot scheduling for four UEs. Each of the UE1, UE2, UE3, and UE4. The plurality of UEs can perform the data transmission over a 5G network. Further, the gNode B scheduler at the 5G network has to schedule the candidates of the four UEs. As shown in FIG. 1A, consider plurality of the UEs performs data transmission over a 5G network. For example, consider each of the UE 1, UE 2, UE 3 and UE 4 is having a UE ID 10, UE ID 245, UE ID 2 and UE ID 19 respectively. Each of the UE1, UE 2, UE 3 and UE 4 is associated with at least one beam ID, priority and Buffer Occupancy (BO). The example values for at least one beam ID, priority and BO are illustrated below in Table 1:

TABLE 1

| UE ID | Beam ID | Priority | BO (units) |
|---|---|---|---|
| 10 | 15 | 1 | 9 |
| 245 | 50 | 2 | 9 |
| 2 | 0 | 3 | 12 |
| 19 | 11 | 4 | 6 |

As shown in Table 1, among all the UEs, the UE ID 10 is having the highest priority with 9 units of data and beam ID 15. Thus, gnodeB scheduler will schedule the candidates of the UE ID 10 first. Further, the gnodeB scheduler will allocate the entire 1 slot for the data transmission at time T0 over a PDCCH 2 (Physical Downlink Control Channel). The UL slot layout is represented in FIG. 1B. Each of the small rectangular boxes in UL slot layout represents a single byte (101). The entire 1 slot comprises 14 symbols (103) (represented on X-axis) and 4 Radio Bearers (RB) (105) (represented on Y axis). The UE ID 10 can utilize 12 symbols (103) in UL slot 1 as represented in FIG. 1A on X-axis. By default 2 symbols for each radio bearer (RB) (105) can be utilized for PUCCH (Uplink Physical Channel), and thus a total to 8 units can be consumed for PUCCH. Similarly, the UE ID 245, is allocated a UL slot 2 using which the candidates of UE ID 245 is transmitted during time T2 over a PDCH 3; UE ID 2 is allocated a UL slot 3 using which the candidates of the UE ID 2 is transmitted during time T2 over PDDCH 4 and UE ID 19 is allocated a UL slot 4 using which the candidates of the UE ID 19 is transmitted during time T3.

Further consider each of the UE ID 245, UE ID 2 and UE 19 consumes same number of units in UL slot 2, UL slot 3 and UL slot 4 respectively as that of UE ID 10 consumed in UL slot 1. Each units indicates the number of radio bearers (RBs) used in frequency grid multiplied with number of symbols used in time domain.

Further, 1 Radio bearer (RB)=12 subcarriers and

1 Resource element=1 subcarriers*1 Orthignal Frequency Division Multiplexing (OFDM) symbol

1 unit=1 RB*1 OFDM

Consider total number of units in each slot available for transmission is 12*4=48 units. Thus for 4 UL slots the total number of resources available are 48*4=192 units+4 PDCCH.

Among total 48 units only 12 units are used by the UE in its respective UL slots. Thus, the total number of resources utilized is in each slot by the UE. Hence, the total number of units utilized by all the 4 UEs are 12*4=48+4 PDCCH symbols.

Total number resources left unutilized=(total available-total consumed)=(192−48)=144 units resources.

Further, total amount of time taken for the data transmission for all the 4 UEs is as shown in below equation:

$$Average Latency : \frac{3 {T}_{1} + 2 {T}_{2} + {T}_{3}}{4} ⟶ 1$$

Thus, the allocation of entire single slot for each UE leads to lot of resource wastage. The amount of time consumed for the data transmission for the plurality of UEs is large.

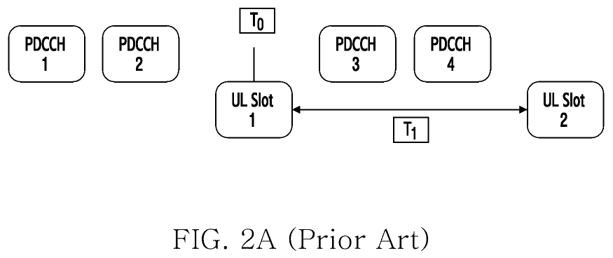

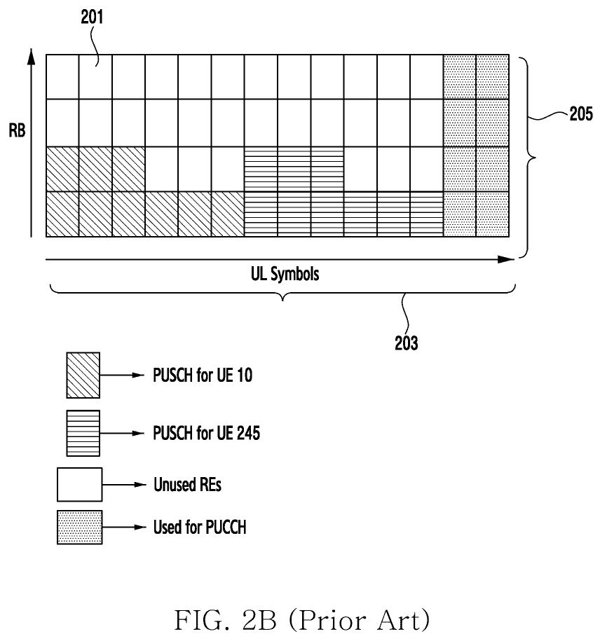

In some existing techniques, as shown in FIG. 2A, the UL slot scheduling can be performed by diving the UL slot into two mini-slots.

Consider a scenario as shown in FIG. 2A the UL slot scheduling for four UEs. Each of the UE1, UE2, UE3, and UE4. The plurality of UEs can perform the data transmission over a 5G network. Further, the gNode B scheduler at the 5G network has to schedule the candidates of the four UEs. As shown in FIG. 2A, consider plurality of the UEs performs data transmission over a 5G network. For example, consider each of the UE 1, UE 2, UE 3 and UE 4 is having a UE ID 10, UE ID 245, UE ID 2 and UE ID 19 respectively. Each of the UE1, UE 2, UE 3 and UE 4 is associated with at least one beam ID, priority and Buffer Occupancy (BO). The example values for at least one beam ID, priority and BO can be as shown in below Table 2:

TABLE 2

| UE ID | Beam ID | Priority | BO (units) |
|---|---|---|---|
| 10 | 15 | 1 | 9 |
| 245 | 50 | 2 | 9 |
| 2 | 0 | 3 | 12 |
| 19 | 11 | 4 | 6 |

As shown in Table 2, among all the UEs, the UE ID 10 is having the highest priority with 9 units of data and beam ID 15. Before the initiation of the scheduling, the gNodeB establishes a Physical Downlink Channel (PDCCH) for each of the UE ID 10, UE ID 245, UE ID 2 and UE ID 19. The PDCCH established includes PDDCH 1 for the UE ID 10, PDCCH 2 for UE ID 245, PDCCH 3 for UE ID 2 and PDCCH 4 for UE ID 19. Further, in a static mini-slot scheduling the gNodeB schedules candidates of two UEs in a single UL slot. For example, the gNodeB schedules the candidates of the UE ID 10 and candidates of the UE ID 245 in the UL slot 1 first during time TO. Further, the gNode B scheduler schedules the candidates of the UE ID 2 and UE ID 19 in UL slot 2 during time T1. The gNode B scheduler schedules the UE ID 10 and UE ID 245 first in UL slot 1 since priority of the UE ID 10 and UE ID 245 are 1 and 2 respectively. Thus, the gNodeB schedules two highest priority UEs in a single UL sot in the static mini-slot scheduling. Thereafter, the gNodeB schedules the UE ID 2 and UE ID 19 having 3^{rd} and 4^{th} priority.

The UL slot allocation for the mini-slot scheduling according to the existing art is as shown in FIG. 2B. During the mini-slot scheduling, the gNodeB allocates a single UL slot for two UEs. The gNodeB divides the single UL slot for the candidate transmission of the two UEs. Each rectangular boxes (201) represents a single byte. The entire 1 slot comprises 14 UL symbols (203) (represented on X-axis) and 4 Radio Bearers (RB) (205) (represented on Y axis). In the existing mini-slot scheduling, the first half of the UL slot can be utilized by the UE ID 10 utilizes and the second of the same UL slot can be utilized by the UE ID 245. For example, 9 symbols of the first half of the UL slot 1 is utilized by the UE ID 10 and the 9 symbols of the second half the UL slot 1 is utilized by the UE ID 245. By default 2 symbols for each radio bearer (RB) (105) can be utilized for PUCCH (Uplink Physical Channel), and thus a total to 8 units can be consumed for PUCCH. Similarly, the gNodeB allocates the UL slot 2 for the UE ID 2 and UE 19. The first half of the UL slot 2 can be utilized for the candidate transmission of the UE ID 2 and the second half of the UL slot 2 can be utilized for the candidate transmission of the UE ID 19.

Hence according to above scenario, four UEs uses 2 UL sots, and each UL slot comprises 12*4=48 units. Thus, the total number of resources available by four UEs is determined to be 2*48=96 units+4 PDCCH symbols.

Further, the number of resource utilized in each slot is 9+9=18 units. Thus, for 2 UL slots the amount of resource utilized is 18*2=36+4 PDCCH symbols.

Thereafter, the amount of resources left utilized in 2 UL slots is 96−36=60 units. Hence, the 60 units is considered to be wasted without any data transmission.

Further, total amount of time taken for the data transmission for all the 4 UEs is as shown in below equation

$$Average Latency : \frac{{T}_{1}}{2} ⟶ 2$$

Thus, the allocation of entire single slot for each UE leads to lot of resource wastage. Also, the amount of time consumed for the data transmission for the plurality of UEs is large. Thus, there is a need for an improved uplink slot scheduling and hence improving the resource utilization over the telecommunication network.

The disclosed method, determines an optimal uplink slot division in a telecommunication network. In the disclosed method the uplink slot division is performed initially determining a Buffer Occupancy of the plurality of UEs, Buffer Occupancy (BO) threshold for each radio bearer from the list of radio bearers. Further, the plurality of UEs are classified into plurality of radio bearer groups based on the BO threshold and BO of each radio bearer from list of radio bearers. Finally, the optimal uplink slot division is determined based on the plurality of radio bearer groups. Hence, the disclosed method dynamically determines whether the division of slot is necessary and also determines the optimal number of divisions in the UL slot for the UL scheduling.

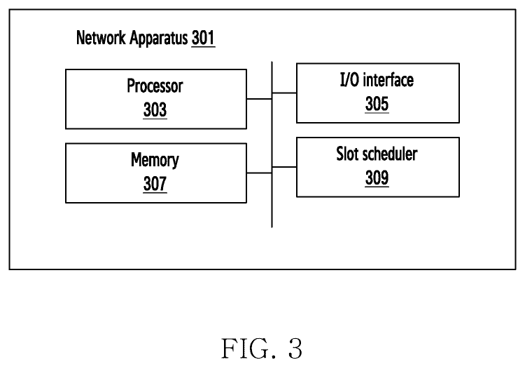

FIG. 3 is a block diagram illustrating an example configuration of a network apparatus for determining an optimal uplink slot division in a telecommunication network, according to various embodiments. The network apparatus (301) includes a processor (e.g., including processing circuitry) (303), an Input/Output (I/O) interface (e.g., including input/output circuitry) (305), a memory (307) and a slot scheduler (e.g., including various circuitry and/or executable program instructions) (309). The network apparatus (301) may be a node in a network that provides connectivity between User equipment and Core network. For example, the network apparatus can be a gNodeB scheduler, a base station, a radio network node and the like. The network apparatus (301) is configured to schedule the uplink transmission for the plurality of UEs. Further, the processor (303) of the network apparatus (301) communicates with the memory (307), the I/O interface (305) and a slot scheduler (309). The processor (303) is configured to execute instructions stored in the memory (307) and to perform various processes. The processor (303) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU). The processor (303) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Further, the memory (307) of the network apparatus (301) includes storage locations to be addressable through the processor (303). The memory (307) is not limited to a volatile memory and/or a non-volatile memory. Further, the memory (307) can include one or more computer-readable storage media. The memory (307) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (307) can store the media streams such as audios stream, video streams, haptic feedbacks and the like.

The I/O interface (305) may include various circuitry and transmits the information between the memory (207) and external peripheral devices. The peripheral devices are the input-output devices associated with the network apparatus (301). The I/O interface (305) receives several information from plurality of UEs, network devices, server and the like.

The slot scheduler (309) of the network apparatus (301) may include various circuitry and/or executable program instructions and communicates with the processor (303), I/O interface (305) and the memory (307) to determine an optimal uplink slot division in a telecommunication network. Initially, the slot scheduler (309) detects a list of radio bearers associated with plurality of UE available in the telecommunication network. Each of the UEs can be associated with plurality of radio bearers. The radio bearer is data transmission channel that is used to transfer the data packets/IP packets between the UE and the slot scheduler.

Further, the slot scheduler (309) may determine a Buffer occupancy (BO) of each radio bearer associated with plurality of UE. The Buffer Occupancy (BO) indicates the amount of data that is currently queued for the transmission. The slot scheduler (309) determines the BO of each radio bearer associated with the plurality of UEs based on the buffer status report received from plurality of UEs. The buffer status reports includes the information related to the amount of data available at each radio bearer associated with plurality of UEs for the uplink data transmission.

Furthermore, the slot scheduler (309) may determine a plurality of BO threshold for each radio bearer associated with the plurality of UEs. The slot scheduler (309) may determine the plurality of BO threshold for each radio bearer based on a first scheduling parameters. The first scheduling parameters includes, but not limited to a Modulation and Coding Scheme (MCS) of the plurality of the UEs, Bandwidth Part Size (BWP) of the plurality of UEs, a minimum symbol length after PUSCH symbols has been classified into specific parts for the plurality of the UE and uplink layer count of the plurality of the UE. The MCS defines the number of bits that can be transmitted per Resource Element (RE). The Bandwidth Part represents a portion extracted from the overall carrier bandwidth. The uplink layer count represents the number of independent streams of data than can be transmitted in the uplink by the UE given current channel conditions. Furthermore, the minimum symbol length represents the minimum symbol length required to satisfy the uplink slot division currently under consideration. For example the determination of the BO threshold follows the 3GPP specification 38.214 Section 6.1.4.2 for Transport Block Size determination. Further, the number of Resource Elements (REs) that can be used for transmission (NREs) is calculated from the BWP size and symbol length. Furthermore the REs is multiplied by MCS code rate, MCS modulation order and number of layers to get the intermediate value N_{info} which will be used as per predefined (e.g., specified) tables in 3GPP specification 38.214 to calculate the transport block size (TBS). Finally, the TBS will be used as the BO threshold.

The slot scheduler (309) may classify the list of radio bearers into a plurality of

radio bearer groups based on the plurality of BO threshold for each radio bearer associated the plurality of UEs and the BO of each radio bearer associated with the plurality of UEs. The classification of the list of radio bearer associated with plurality of UEs is performed by determining the BO threshold and transmission capability of plurality of UEs. The transmission capability of the UE is determined based on the MCS, bandwidth part size, and uplink layer count. Upon determining, the slot scheduler (309) groups each of the radio bearers by comparing the BO of each radio bearer with plurality of BO threshold of each radio bearer from the list of radio bearers associated with plurality of UEs, Further each of the radio bearer is grouped such that the at least one radio bearers in the group comprises the smallest BO threshold among the plurality of BO threshold and the BO threshold being greater than or equal to the BO. Hence, each radio bearer is classified under group Gr_{I} for the largest i<=k_{div} satisfying the condition BO_{Th}_{ⁱ⁺¹}^{UE}<BO_{Bearer}≤BO_{Th}_{ⁱ}^{UE}, where BO_{Bearer} indicates the Buffer Occupancy of the radio bearer, BO_{Th}_{ⁱ⁺¹}^{UE}, BO_{Th}_{ⁱ}^{UE} indicates the at least one Buffer occupancy threshold of the radio bearer associated with the UE.

For example, the plurality of BO threshold is determined for each of the radio bearers from the list of radio bearers. Further, a minimum BO threshold which is greater than or equal to the Buffer Occupancy of the radio bearer is selected from the plurality of BO threshold determined for the radio bearer.

The slot scheduler (309) may determine an optimal uplink slot division based on the plurality of radio bearer groups. Upon grouping, the slot scheduler (309), may select at least one radio bearer group which is having the highest priority radio bearers from the plurality of radio bearer groups. The priority of the radio bearers can be decided based on at least one buffer occupancy, transmission capability of the UE, and scheduling history. Further, the slot scheduler (309) may detect a radio bearer group among the at least one selected radio bearer group which is having the lowest number of divisions possible in the slot. The number of divisions required by each radio bearer from the list of radio bearer is determined based on the BO and the BO threshold of the radio bearer. The slot scheduler (309) may determine the optimal slot division by allocating the lowest number of divisions as the optimal division for a current slot.

The slot scheduler (309) may, for example, and without limitation, determine the optimal slot division in the UL slot using the below steps:
Step 1: Consider Rhighest be the highest priority among the candidates to be scheduled in this slot
Step 2: div=K_{div}, where K_{div} represents the maximum number of possible divisions in the system. The div represents the optimal number of divisions to be performed in the UL slot. At the beginning, the value of div is initialized with a maximum number of possible division (K_{div}) in the system.
Step 3: For all Grᵢ if Rᵢ=R_{highest}. In this step, the slot scheduler checks if the BO Group has a bearer with highest priority.
Step 4: div=min (div, i). In this step, the group i which is having the highest priority is chosen. Further the value of div is updated by comparing the initialized div value with the i value. For example consider the K_{div} value being 4 and the group which is having the highest priority is Gr₃. The div value is updated by determining minimum (4, 3). The minimum value is 3 and hence the div value is updated to 3.
Step 5: If div==0.

don't divide. At step 5, the slot scheduler checks whether the updated div value is equal to Zero. If, it is determined to be zero, then the slot scheduler does not perform any divisions in the UL slot for the uplink transmission.
Step 6: Else pass the value of div to next block. However, if the updated div value is not zero, then the slot scheduler repeats the above iteration and stops the above iteration until a minimum value for the div is determined. Finally, the optimal slot division value is the minimum division value determined for each of the radio bearer.

Upon decision of the div value, the slot scheduler (309) may further parse the list of radio bearers and determines a final value of the number of divisions to be made for the UL slot and a corresponding ratio in which divisions should be performed based on the number of Physical Uplink Shared Channel (PUSCH) symbols.

In an embodiment, consider a scenario of Multi User-Multiple Input Multiple Output (MU-MIMO), where multiple UEs transmits data in same time but in different frequency. For example, the multiple UEs transmits data in same symbol but in different RBs. Further, MU-MIMO UEs can be scheduled by standard approaches like treating the MU-pair as a single UE and scheduling it with the algorithm.

In an embodiment, the slot scheduler (309) may determine the optimal slot division in a telecommunication network using a Machine Learning (ML) model. The slot scheduler (309) may determine the optimal slot division using the ML model when the ULPRB (Uplink Physical Resource Block) usage metrics exceeds a predefined threshold value. The threshold value may indicate that a sufficient amount of data is collected for determining the optimal slot division using the Machine Learning (ML) model. The ML model may, for example, and without limitation, be a simple Artificial Neural Network (ANN) framework with one input layer, 2 intermediate layers and an output layer. However, if the UL PRB usage metrics does not exceed a predefined threshold value, then the optimal slot division is determined based on the BO threshold and the BO of each of the radio bearers associated with the plurality of UEs.

The slot scheduler, may initially input a plurality of second scheduling parameters of list of radio bearers to the ML model. The number of radio bearers from the list of radio bearers can be determined to keep the computation complexity low and also ensuring the best real-time decision-making capacity. The plurality of second scheduling parameters of the each of the radio bearer includes but not limited to, the BO of each radio bearer from the list of radio bearers, a Modulation and Coding scheme (MCS) of the plurality of UE, bandwidth part size of the (BWP) of the plurality of UE, a minimum symbol length after PUSCH symbols has been classified into specific parts for the plurality of UE, a uplink layer count of the plurality of UE, BO size of each radio bearer from list of radio bearers, frequency of serving beam of each radio bearer from a list of radio bearers, and a multi-label encoded MU-MIMO pairing data of the radio bearers. Further, the first intermediate layer of the ML model will execute an activation function, where the activation function is a Rectified Linear Unit (ReLU) function. For example, at the first intermediate layer, similar radio bearers from plurality of radio bearers are grouped together and generates weights for the suitability of optimal slot division. Furthermore, at the second intermediate layer of the ML model executes another activation function namely SoftMax. The Softmax function may generate a discrete level of output from preceding layers, where the discrete levels represent the optimal uplink slot division. Finally, the ML model determines an optimal slot division based on the SoftMax function classification.

In various embodiments, a server can be associated with the slot scheduler (309) and the server associated with the slot scheduler (309) can execute the ML model for the determination of the optimal slot division in a telecommunication network.

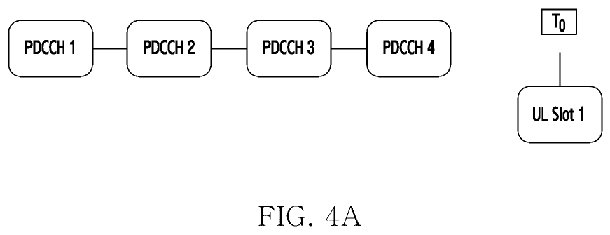

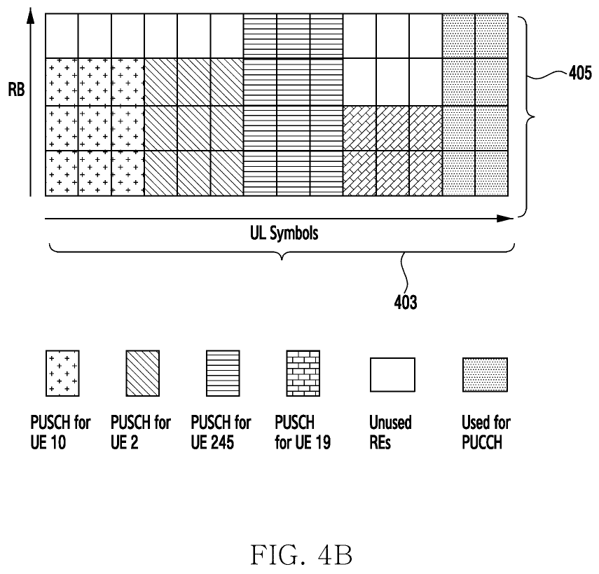

FIG. 4B is a diagram illustrating an example Uplink slot layout during mini-UL slot scheduling, according to various embodiments. As shown in FIG. 4B consider an example scenario of determining an optimal slot division for four UEs. Consider the four UEs is associated with a UE ID, a beam ID, priority and the Buffer Occupancy. The UE ID represents an unique identification number of the UE. Further the Beam ID represents beam restriction of the UE, and priority represents the importance or urgency of the candidate transmission. Also, the Buffer Occupancy (BO) represents the amount of data that is queued at the radio bearer for the transmission. Further the values for each of the UE ID, beam ID, priority and BO for all the four UEs is as shown in below table 3:

TABLE 3

| UE ID | Beam ID | Priority | BO (units) |
|---|---|---|---|
| 10 | 15 | 1 | 9 |
| 245 | 50 | 2 | 9 |
| 2 | 0 | 3 | 12 |
| 19 | 11 | 4 | 6 |

FIG. 4A is a diagram illustrating example optimal Uplink (UL) mini slot scheduling, according to various embodiments. As shown in FIG. 4A initially Physical Downlink Control Channel (PDCCH) is assigned to each of the UEs. The PDCCH can be used to carry scheduling information to each of the UEs. For example, referring to table 3, the UE ID 10 can be assigned with the PDDCH 1, UE ID 245 with PDCCH 2, UE ID 2 with PDCCH 3 and UE ID 19 with PDCCH 4. Further, the candidate transmission for all the four UEs is determined to be allocated in a single slot, where the number of optimal divisions is determined to be Four for the UL transmission. Hence, the UL slot 1 is allocated for the UL transmission for all the Four UEs (UE ID 10, UE ID 245, UE ID 2 and UE 19) at time T0. The single UL slot allocation for all the four UEs is as shown in FIG. 4B.

As shown in FIG. 4B, each of the rectangular box in UL slot layout indicates a single byte. Further it can be observed that the X-axis of the UL slot layout represents the UL symbols (403) and the Y-axis represents the Radio Bearers (405). Further, consider the UE ID 10 consumes 9 units, UE ID 245 consumes 9 units, UE ID 2 consumes 12 units and UE ID 19 consumes 6 units in the UL slot.

Thus, the total number of resources consumed by all the four UEs is 36 units+4 PDCCH symbols. Also, the total number of resources in the UL slot=12*4=48 units+4 PDCCH symbols. Hence, the unused resources=48−36=12 units. Thus, the four division of the UL slot for UL transmission number of the four UEs leads to the less wastage of the resources when compared to the conventional techniques as shown in FIG. 1B and FIG. 2B. Also, the latency determined to be zero, since all the Four UEs are transmitted at time T0.

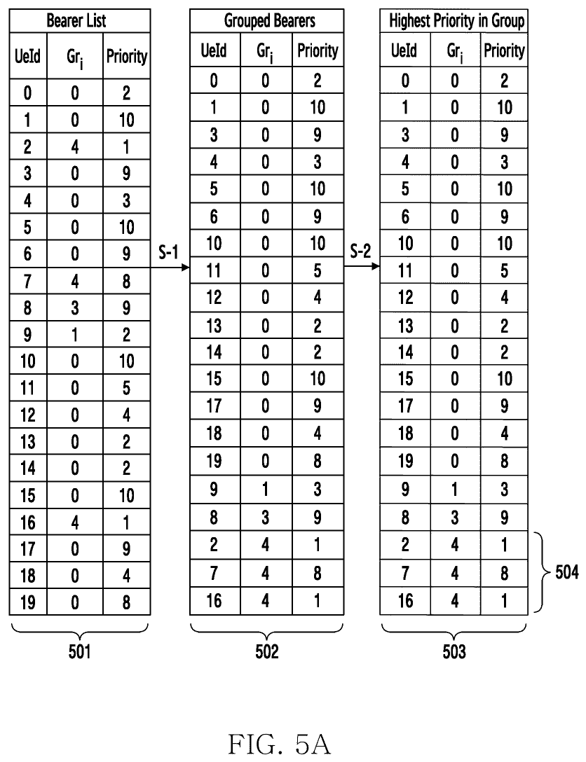

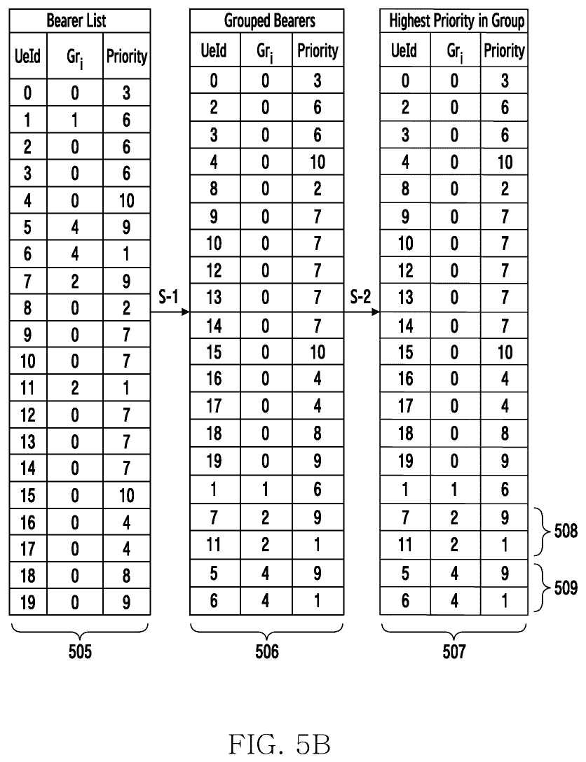

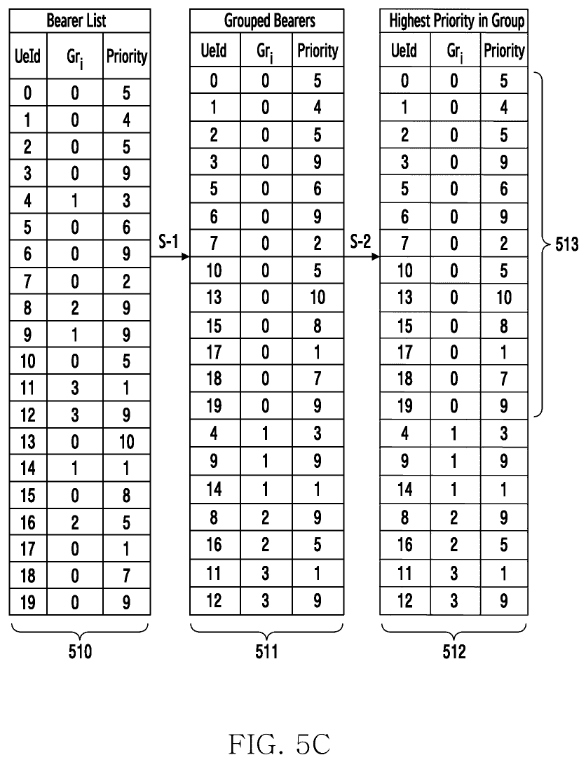

FIG. 5A is a tabular representation illustrating an example of grouping plurality of UEs for determining optimal uplink slot division, according to various embodiments.

FIG. 5A illustrates an example scenario of grouping the plurality of radio bearers and determining an optimal slot division for the selected group of radio bearers. Consider a plurality of UEs having UE ID ranging from 0-19. The slot scheduler (309) determines the Buffer Occupancy and the Buffer Occupancy threshold for each of the UE (UE ID 0-19). Upon determining the slot scheduler (309) groups the plurality of UEs (UE ID 0-UE ID 19) into particular groups represented in table (501) under the column (Grᵢ). For example, the UE ID 0 can belong to group Gro, UE ID 2 can belong to group Gr_{4 and} the like. Further, each of the UE ID 0-UE ID 19 comprises a priority as indicated under the column “Priority” in table (501). For example, the priority of UE ID 0 is having a value as 2, UE ID 2 is having a priority value as 1. Further, at step S-1, the slot scheduler (309) groups all the UEs based on the BO threshold. For example, the UE ID (0, 1, 2, 3, 4, 5, 6, 10, 11, 12, 13, 14, 15, 17, 18 and 19) belonging to Gr₀ is combined as shown in table 502, where the UEs of Gr₀ is determined to have similar BO thresholds. Similarly, the UE ID (9) belongs to group Gr₁ and UE ID 8 belongs to Gr₃ as shown in table 502. Also, the UE ID (2, 7, 16) belongs to Gr₄ as shown in table 502. Further at step S-2, the slot scheduler (309) selects the groups having the highest priority UEs (Highest priority represents the lower value of the priority). For example, consider the priority of the UE ID in groups having the priority value as 1 is higher when compared to the UE ID having the priority value 2. Hence, as shown in table 503, the slot scheduler selects the group Gr₄ (504) for the UL transmission and the optimal slot division having value 4. Thus, the optimal number of divisions is determined to 4 for the uplink transmission of UE ID 2, UE ID 7 and UE ID 16.

FIG. 5B is a tabular representation illustrating an example of grouping plurality of UEs for determining optimal uplink slot division, according to various embodiments.

FIG. 5B illustrates an example scenario of grouping the plurality of radio bearers and determining an optimal slot division for the selected group of radio bearers. Consider a plurality of UEs having UE ID ranging from 0-19. The slot scheduler (309) determines the Buffer Occupancy and the Buffer Occupancy threshold for each of the UE (UE ID 0-19). Upon determining the slot scheduler (309) groups the plurality of UEs (UE ID 0-UE ID 19) into particular groups represented in table (505) under the column (Grᵢ). For example, the UE ID 0 can belong to group Gr₀, UE ID 2 can belong to group Gr_{4 and} the like. Further, each of the UE ID 0-UE ID 19 comprises a priority as indicated under the column “Priority” in table (501). For example, the priority of UE ID 11 is having a value as 1, UE ID 8 is having a priority value as 6. Further, at step S-1, the slot scheduler (309) groups all the UEs based on the BO threshold. For example, the UE ID (0, 2, 3, 4, 8, 9, 10, 12, 13, 14, 15, 16, 17, 18, 19) belonging to Gr₀ is combined as shown in table 506, where the UEs of Gr₀ is determined to have similar BO thresholds. Similarly, the UE ID (1) belongs to group Gr₁ and UE ID 7, 11 belongs to Gr₂ as shown in table 506. Also, the UE ID (5, 6) belongs to Gr₄ as shown in table 506. Further at step S-2, the slot scheduler (309) selects the groups having the highest priority UEs (Highest priority represents the lower value of the priority). For example, consider the priority of the UE ID in groups having the priority value as 1 is higher when compared to the UE ID having the priority value 2. Hence, as shown in table 507, the slot scheduler (309) selects the group Gr₂ (508) and Gr₄ (509). Further the slot scheduler (309) selects a group which is having the lowest number of divisions as the optimal number of divisions for the uplink transmission. Hence, the slot scheduler (309) selects the group Gr₂ for the UL transmission, and the optimal number of divisions in the UL slot is determined to be as 2. 2 divisions in the UL slot will comprise 3 parts in the UL slot. Finally, the slot scheduler (309) transmits the candidates of the UE ID 7 and UE 11 in the same UL slot. The UE ID 11 can be transmitted in the first part of the UL slot, and the UE ID 7 can be transmitted in the second part. However, there is another part left unused in the UL slot. Hence, the UE ID 6 (which belongs to Gr₄ (509)) having the highest priority can also be transmitted in the same UL slot. Thus, the optimal number of divisions is determined to 4 for the uplink transmission of UE ID 2, UE ID 7 and UE ID 16.

FIG. 5C is a tabular representation illustrating an example of grouping plurality of UEs for determining optimal uplink slot division, according to various embodiments.

FIG. 5C represents an example scenario of grouping the plurality of radio bearers and determining an optimal slot division for the selected group of radio bearers. Consider a plurality of UEs having UE ID ranging from 0-19. The slot scheduler (309) determines the Buffer Occupancy and the Buffer Occupancy threshold for each of the UE (UE ID 0-19). Upon determining, the slot scheduler (309) groups the plurality of UEs (UE ID 0-UE ID 19) into particular groups represented in table 510 under the column (Grᵢ). For example, the UE ID 0 can belong to group Gr₀, UE ID 4 can belong to group Gr₁ and the like. Further, each of the UE ID 0-UE ID 19 comprises a priority as indicated under the column “Priority” in table (510). For example, the priority of UE ID 11 is having a value as 1, UE ID 8 is having a priority value as 9. Further, at step S-1, the slot scheduler (309) groups all the UEs based on the BO threshold. For example, the UE ID (0, 1, 2, 3,5, 6, 7, 10, 13, 15, 17, 18, 19) belonging to Gr₀ is combined as shown in table 511, where the UEs of Gr₀ is determined to have similar BO thresholds. Similarly, the UE ID (4, 9, 14) belongs to group Gr₁ and UE ID (8, 16) belongs to Gr₂ as shown in table 511. Also, the UE ID (11, 12) belongs to Gr₃ as shown in table 511. Further at step S-2, the slot scheduler (309) selects the groups having the highest priority UEs (Highest priority represents the lower value of the priority). For example, consider the priority of the UE ID in groups having the priority value as 1 is higher when compared to the UE ID having the priority value 2. Hence, as shown in table 512, the slot scheduler (309) selects all the group Gr₀, Gr₁ and Gr₂, since each of the groups has the highest priority UEs. Further the slot scheduler (309) selects a group which is having the lowest number of divisions as the optimal number of divisions for the uplink transmission. Hence, the slot scheduler (309) in this scenario does not perform any divisions in the UL slot, since the lowest number of divisions is 0. Finally, the slot scheduler (309) schedules the candidate transmission of each of the UE IDs (0-19) based on its priority in the UL slot without any further divisions.

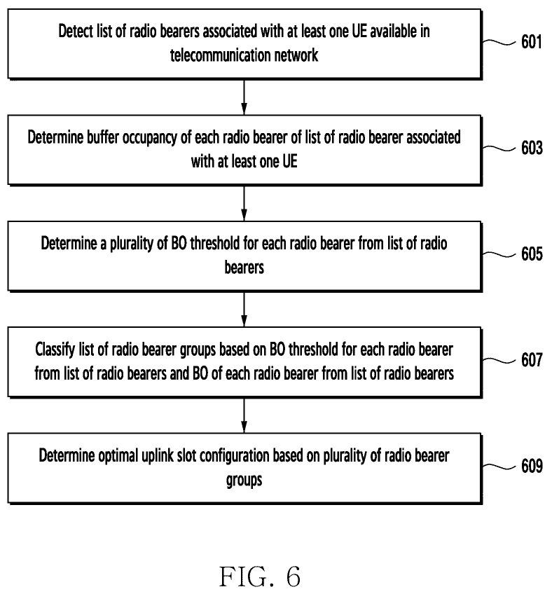

FIG. 6 is a flowchart illustrating an example method of determining an optimal uplink slot division in telecommunication network, according to various embodiments.

In an embodiment, at step S-601, the slot scheduler (309) detects a list of radio bearers associated with at least one UE available in the telecommunication network. The radio bearer is a physical channel used responsible for transmission between the User Equipment (UE) and the network apparatus. Each of the UE can be associated with one or more radio bearers for the uplink and downlink transmission with the network apparatus. The network apparatus is a network node that is used to schedule candidates queued at the radio bearers associated with the UE.

In an embodiment, at step S-603, the slot scheduler (309) the slot scheduler (309) determines a Buffer Occupancy (BO) of each radio bearer of the list of radio bearers associated with the plurality of UE. The Buffer Occupancy is determined based on a buffer status report received by the UE, where the buffer status report indicates the amount of data available at each radio bearer associated with the UE for the uplink transmission.

In an embodiment, at step S-605, the slot scheduler (309) determines a plurality of BO thresholds for each radio bearer from the list of radio bearers. The BO threshold is determined based on a first scheduling parameters and transmission capability of the UE based on the current channel conditions. The first scheduling parameters includes at least one of Buffer Occupancy (BO), Modulation and Coding scheme (MCS) of plurality of the UE, bandwidth part size of the plurality of UE, a minimum symbol length after PUSCH symbol has been classified into specific parts for the plurality of UE, and a uplink layer count of the plurality of UE.

In an embodiment, at step 607, the slot scheduler (309) classifies the list of radio bearers into a plurality of groups based on the BO threshold for each of the radio bearers associated with the UE and the BO of each of the radio bearer from the list of radio bearers. The classification may be performed by comparing the BO of each of the radio bearer with the plurality of BO threshold of each of the radio bearer associated with the plurality of UEs. Further, each group comprises the plurality of the radio bearers having similar smallest BO threshold of the plurality of BO threshold which is greater than the Buffer Occupancy (BO) of the plurality of radio bearers.

In an embodiment, at step 609, the slot scheduler determines an optimal uplink slot division based on the plurality of radio bearer groups. The determination of the optimal slot division is performed by selecting at least one of the classified radio bearer groups which is having the highest priority radio bearer. The optimal number of division may be determined by detecting the selected radio group having the lowest number of divisions. Finally, the slot scheduler (309) allocates the determined optimal number of slot divisions for the plurality of radio bearers associated with the UE for the UL transmissions of the candidates queued at the plurality of radio bearers associated with the UEs.

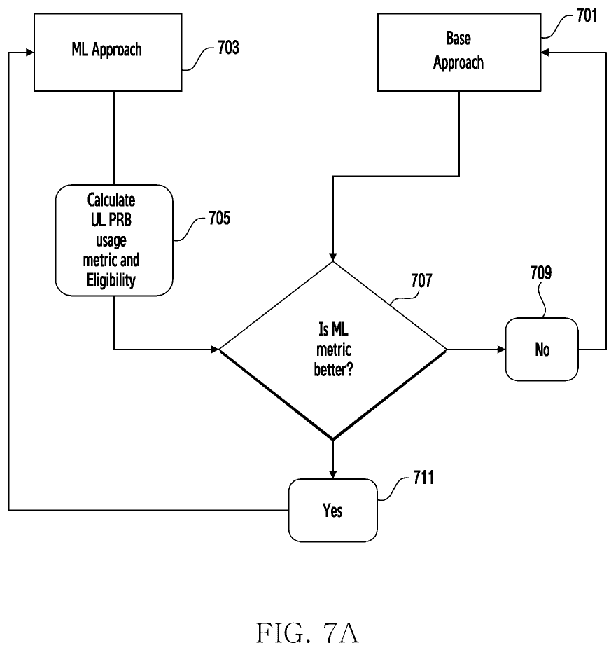

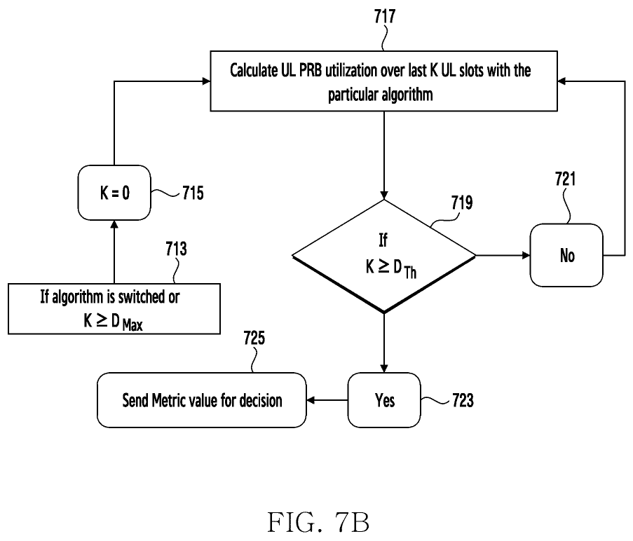

FIG. 7A is a flowchart illustrating example switching between the ML model and a base model for the determination of optimal uplink slot configuration, according to various embodiments.

At block 701, a base approach is executed for determining the optimal uplink slot division for the uplink transmission. In the base approach, the optimal uplink slot division is determined based on the Buffer Occupancy and Buffer Occupancy threshold of the plurality of UEs. Further, the determined optimal uplink slot division is transmitted to block 707.

At block 703, the optimal uplink slot division is determined by a Machine Learning model. Before the executing the ML approach, an Uplink Physical Resource Block (UL PRB) usage metric is determined. The UL PRB usage indicates whether a sufficient amount of data is collected for training at block 705. Once, the UL PRB usage metric meets the eligibility criteria, that is when the sufficient amount of data is collected, the ML approach determines the optimal uplink slot division using the second scheduling parameters. The second scheduling parameters includes, but not limited to a the BO of each radio bearer from the list of radio bearers, a Modulation and Coding scheme (MCS) of the plurality of UE, bandwidth part size of the (BWP) of the plurality of UE, a minimum symbol length after PUSCH symbols has been classified into specific parts for the plurality of UE, a uplink layer count of the plurality of UE, BO size of each radio bearer from list of radio bearers, frequency of serving beam of each radio bearer from a list of radio bearers, and a multi-label encoded MU-MIMO pairing data of the radio bearers. Further, the determined optimal uplink slot divisions is forwarded to block 707.

At block 707, the optimal uplink slot divisions determined by the base approach and the optimal uplink slot divisions is determined by the ML approach is received. Further, the optimal uplink slot divisions determined by the base approach and the optimal uplink slot divisions is determined by the ML approach is compared. Upon comparison, when the optimal uplink slot division determined by the base approach is determined to be better, then at block 709, the further uplink scheduling for the plurality of UEs is performed by the base approach (701). However, when the optimal uplink slot division determined by the ML approach is determined to be better, then at block 711, the further uplink scheduling for the plurality of UEs is performed to the ML approach (703).

FIG. 7B is a flowchart illustrating example determination of eligibility of Upper Link Physical Resource Block (UL PRB) usage metrics, according to various embodiments.

The eligibility of UL PRB usage metrics is determined as shown in FIG. 7B. Initially at block 713, it is determined whether the decision for optimal uplink slot division is switched to the ML approach.

Upon switching, to the ML approach, at block 715, the value of “K” is initialized to zero. The “K” indicates the amount of UL slots, that is used for the uplink transmission.

At block 717, the UL PRB utilization is determined for the last K UL slots with a particular approach (For example, using a base approach). The UL PRB utilization indicates whether a sufficient amount of data of collected for training the ML model.

At block 719, it is the determined whether UL PRB usage metrics exceeds a predefined threshold value. If the UL PRB utilization is greater than or equal to the pre-defined threshold, then at block 723 and 725, the UL PRB metric value is sent for the decision making, as indicated in block 707 in FIG. 7A.

However, if the UL PRB usage metrics is less than the pre-defined threshold value, then at block 721, then the determination of UL PRB usage metric is continued until a sufficient amount of data is collected for training the ML model.

The method of the present disclosure, dynamically divides the UL slot based on the Buffer occupancy of plurality of UEs and BO threshold of the plurality of UEs.

The optimal uplink slot division maximizes and/or improves the UL PRB utilization and also minimizes and/or reduces the UL scheduling latency.

Further, a degree of flexibility is achieved for the uplink transmission for the plurality of UEs having different beam restrictions and thus preventing/reducing the UL PRB wastage.

Further, the present disclosure, discloses a method of determining the optimal uplink slot divisions using an ML model based on the second scheduling parameters.

In embodiments, a method of determining an optimal uplink slot division in a telecommunication network is provided. The method comprises detecting a list of radio bearers associated with plurality of user equipment (UE) available in the telecommunication network; determining a Buffer Occupancy (BO) of each radio bearer of the list of radio bearers associated with the plurality of UE; determining a plurality of BO thresholds for each radio bearer from the list of radio bearers; classifying the list of radio bearers into a plurality of radio bearer groups based on the plurality of BO thresholds for each radio bearer from the list of radio bearers and the BO of each radio bearer from the list of radio bearers; and determining the optimal uplink slot division based on the plurality of radio bearer groups.

For example, the determining the optimal uplink slot division for scheduling in the telecommunication network based on the plurality of radio bearer groups comprises selecting at least one radio bearer group having a highest priority among radio bearers from the plurality of radio bearer groups, wherein the highest priority radio bearers has a maximum BO; detecting a radio bearer group among the at least one selected radio bearer group having a lowest number of divisions possible in a slot; and determining the optimal uplink slot division by allocating the lowest number of divisions as optimal division for a current slot.

For example, determining the optimal uplink slot division in a telecommunication network comprises determining an Uplink Physical Resource Block (UL PRB) usage metric for at least one machine learning model; determining whether the UL PRB usage metric meets a UL PRB usage metric threshold; and performing, by a server associated with a network apparatus: determining a plurality of second scheduling parameters associated with at least one UE based on the UL PRB usage metric meeting the UL PRB usage metric threshold, inputting the plurality of second scheduling parameters to the at least one ML model; and determining, by the ML model an optimal uplink slot division in a telecommunication network based on plurality of second scheduling parameters.

For example, the plurality of first scheduling parameters comprises at least one of the BO of each radio bearer from the list of radio bearers, a Modulation and Coding scheme (MCS) of the plurality of UE, bandwidth part size of the (BWP) of the plurality of UE, a minimum symbol length after physical uplink shared channel (PUSCH) symbols have been classified into specific parts for the plurality of UE, and a uplink layer count of the plurality of UE.

For example, the plurality of second scheduling parameters comprises at least one of the BO of each radio bearer from the list of radio bearers, a Modulation and Coding scheme (MCS) of the plurality of UE, bandwidth part size of the (BWP) of the plurality of UE, a minimum symbol length after PUSCH symbols have been classified into specific parts for the plurality of UE, a uplink layer count of the plurality of UE, BO size of each radio bearer from list of radio bearers, frequency of serving beam of each radio bearer from a list of radio bearers, and a multi-label encoded multi user-multiple input multiple output (MU-MIMO) pairing data of the radio bearers.

For example, the MCS of the plurality of UE corresponds to the list of radio bearers and includes modulation order consideration, and wherein the uplink layer count of the plurality of UE corresponds to the list of radio bearers.

For example, determining the BO of each radio bearer of the list of radio bearers associated with the plurality of UE comprises receiving a buffer status report by the UE, wherein the buffer status report includes amount of data available at each radio bearer of the list of radio bearer associated with the UE for uplink transmission; determining a buffer occupancy of each radio bearer of the list of radio bearers associated with the plurality of UE based on the buffer status report of the UE.

For example, classifying the list of radio bearers into a plurality of radio bearer groups based on the plurality of BO threshold for each radio bearer from the list of radio bearers and the BO of each radio bearer from the list of radio bearers comprises determining, the plurality of BO threshold for each radio bearer of the list of radio bearers associated with plurality of UE based on plurality of first scheduling parameters, and transmission capability of plurality of UE based on current channel conditions; grouping, each of the radio bearers of the list of radio bearers associated with plurality of UE by comparing the BO of each of the radio bearer of list of radio bearers with plurality of BO threshold of each radio bearer of list of radio bearers associated with the plurality of UEs, wherein at least one group comprises at least one radio bearer having a smallest BO threshold among the plurality BO thresholds, such that the BO threshold is greater than or equal to the BO of the UE.

For example, determining the UL PRB usage metric for at least one machine learning model comprises: determining a number of uplink slots for which uplink scheduling has been performed; determining whether the number of slots utilized for uplink scheduling exceeds a specified threshold value; transmitting, the number of slots utilized for uplink scheduling, based on the number of slots utilized for uplink scheduling being greater than the specified threshold for performing the optimal uplink slot division using at least one plurality of first scheduling parameters or plurality of second scheduling parameters.

In embodiments, a network apparatus configured to determine an optimal uplink slot division in a telecommunication network is provided. The network apparatus comprises a memory; at least one processor, comprising processing circuitry; and a slot scheduler, comprising circuitry, communicatively coupled to the memory and at least one processor, configured to detect a list of radio bearers associated with plurality of user equipment (UE) available in the telecommunication network; determine a Buffer Occupancy (BO) of each radio bearer of the list of radio bearers associated with the plurality of UE; determine a plurality of BO threshold for each radio bearer of the list of radio bearers; classify the list of radio bearers into a plurality of radio bearer groups based on the plurality of BO thresholds for each radio bearer of the list of radio bearers and the BO of each radio bearer from the list of radio bearers; and determine the optimal uplink slot division based on the plurality of radio bearer groups.

For example, wherein to determine the optimal uplink slot division for scheduling in the telecommunication network based on the plurality of radio bearer groups comprises: selecting at least one radio bearer group having a highest priority among radio bearers from the plurality of radio bearer groups, wherein the highest priority radio bearers have a maximum BO; detecting a radio bearer group among the at least one selected radio bearer group having a lowest number of divisions possible in a slot; and determining the optimal uplink slot division by allocating the lowest number of divisions as optimal division for a current slot.

For example, to determine optimal uplink slot division in a telecommunication network, a server associated with the network apparatus is configured to determine, an Uplink Physical Resource Block (UL PRB) usage metric for at least one machine learning model; determine whether the UL PRB usage metric meets a UL PRB usage metric threshold; and determine a plurality of second scheduling parameters associated with at least one UE based on the UL PRB usage metric meeting the UL PRB usage metric threshold, input the plurality of second scheduling parameters to ML model; and determine, by the ML model an optimal uplink slot division in a telecommunication network based on plurality of second scheduling parameters.

For example, the plurality of first scheduling parameters comprises at least one of the BO of each radio bearer from the list of radio bearers, a Modulation and Coding scheme (MCS) of the plurality of UE, bandwidth part size of the (BWP) of the plurality of UE, a minimum symbol length after physical uplink shared channel (PUSCH) symbols have been classified into specific parts for the plurality of UE, and a uplink layer count of the plurality of UE.

For example, the plurality of second scheduling parameters comprises at least one of the BO of each radio bearer from the list of radio bearers, a Modulation and Coding scheme (MCS) of the plurality of UE, bandwidth parts of the (BWP) of the plurality of UE, a minimum symbol length after PUSCH symbols has been classified into specific parts for the plurality of UE, a uplink layer count of the plurality of UE, BO size of each radio bearer from list of radio bearers, frequency of serving beam of each radio bearer from a list of radio bearers, and a multi-label encoded multi user-multiple input multiple output (MU-MIMO) pairing data of the radio bearers.

For example, the MCS of the plurality of UE corresponds to the list of radio bearers and includes modulation order consideration, and wherein the uplink layer count of the plurality of UE corresponds to the list of radio bearers.

For example, to determine the BO of each radio bearer of the list of radio bearers associated with the plurality of UE comprises receiving a buffer status report by the UE, wherein the buffer status report includes amount of data available at each radio bearer of the list of radio bearer associated with the UE for uplink transmission; and determining a buffer occupancy of each radio bearer of the list of radio bearers associated with plurality of UE based on the buffer status report of the UE.

For example, to classify the list of radio bearers into a plurality of radio bearer groups based on the plurality of BO thresholds for each radio bearer of the list of radio bearers and the BO of each radio bearer of the list of radio bearers comprises determining the plurality of BO thresholds for plurality of UE based on at least one plurality of first scheduling parameters and transmission capability of plurality of UE; group, each of the UE by comparing the BO of each UE with plurality of BO thresholds of plurality of UEs, wherein at least one group comprises at least one UE having a smallest BO threshold among the plurality BO threshold, such that the BO threshold is greater than or equal to the BO of the UE.

For example, to determine the UL PRB usage metric for at least one machine learning model comprises: determining a number of uplink slots for which uplink scheduling has been performed; determine whether the number of slots utilized for uplink scheduling exceeds a specified threshold value; transmit the number of slots utilized for uplink scheduling, based on the number of slots utilized for uplink scheduling being greater than the specified threshold for performing the optimal uplink slot division using at least one plurality of first scheduling parameters or plurality of second scheduling parameters.

In embodiments, a method performed by a network apparatus is provided. The method comprises obtaining a list of radio bearers associated with plurality of user equipments (UEs); classifying the list of radio bearers into a plurality of radio bearer groups based on information on a number of divisions possible in an uplink slot, for each radio bearer of the list of radio bearers associated with the plurality of UEs; identifying a radio bearer group from the plurality of radio bearer groups based on a radio bearer having a highest priority and the information on the number of divisions for each radio bearer; and performing resource allocation for at least one UE associated with the identified radio bearer group.

For example, the identifying of the radio bearer group comprises identifying, among the plurality of radio bearer groups, at least one radio bearer group, each radio bearer group of the selected at least one radio bearer group, wherein the highest priority indicates a maximum buffer occupancy (BO); and identifying, among the at least one identified radio bearer group, the radio bearer group having a lowest number of divisions possible in a slot.

For example, the performing of the resource allocation comprises determining an uplink physical resource block (UL PRB) usage metric for at least one machine learning (ML) model; determining whether the UL PRB usage metric meets a UL PRB usage metric threshold; and obtaining uplink slot division based on the at least one ML model using a plurality of scheduling parameters associated with at least one UE. The plurality of scheduling parameters is determined based on the UL PRB usage metric meeting the UL PRB usage metric threshold.

For example, the plurality of scheduling parameters include at least one of the BO of each radio bearer from the list of radio bearers, a modulation and coding scheme (MCS) for each UE of the plurality of UEs, bandwidth part size of the (BWP) for each UE of the plurality of UE, a minimum symbol length after physical uplink shared channel (PUSCH) symbols have been classified into specific parts for each UE of the plurality of UEs, a uplink layer count for each UE of the plurality of UEs, BO size of each radio bearer from list of radio bearers, frequency of serving beam of each radio bearer from a list of radio bearers, or a multi-label encoded multi user-multiple input multiple output (MU-MIMO) pairing data of the radio bearers.

For example, determining the BO of each radio bearer of the list of radio bearers associated with the plurality of UEs comprises receiving a buffer status report by each UE, wherein the buffer status report includes amount of data available at each radio bearer of the list of radio bearer associated with the corresponding UE for uplink transmission; and determining the BO of each radio bearer of the list of radio bearers associated with the plurality of UEs based on the received buffer status report.

For example, classifying the list of radio bearers into the plurality of radio bearer groups comprises determining a plurality of BO thresholds for each radio bearer of the list of radio bearers associated with plurality of UE based on a plurality of scheduling parameters and transmission capability of each UE; and grouping each of the radio bearers of the list of radio bearers associated with plurality of UE by comparing a BO of each of the radio bearer of list of radio bearers with BO thresholds for a corresponding bearer of the list of radio bearers associated with the plurality of UEs.

For example, the information on the number of divisions is determined based on a buffer occupancy of a radio bearer and a smallest BO threshold using at least one scheduling parameter of a UE corresponding to the radio bearer.

For example, a number of divisions for the radio bearer is determined such that a BO threshold in case of the number of divisions for the radio bearer is smallest in a set of BO thresholds that are greater than the buffer occupancy of the radio bearer.

In embodiments, a network apparatus is provided. The network apparatus comprises at least one processor, comprising processing circuitry; and memory storing instructions that, when executed by the at least one processor, causes the network apparatus to obtain a list of radio bearers associated with plurality of user equipments (UEs); classify the list of radio bearers into a plurality of radio bearer groups based on information on a number of divisions possible in an uplink slot, for each radio bearer of the list of radio bearers associated with the plurality of UEs; identify a radio bearer group from the plurality of radio bearer groups based on a radio bearer having a highest priority and the information on the number of divisions for each radio bearer; and perform resource allocation for at least one UE associated with the identified radio bearer group.

For example, the instructions, when execute by the at least one processor, cause the network apparatus to identify, among the plurality of radio bearer groups, at least one radio bearer group, each radio bearer group of the selected at least one radio bearer group, wherein the highest priority indicates a maximum buffer occupancy (BO); and identify, among the at least one identified radio bearer group, the radio bearer group having a lowest number of divisions possible in a slot.

For example, the instructions, when execute by the at least one processor, cause the network apparatus to determine an uplink physical resource block (UL PRB) usage metric for at least one machine learning (ML) model; determine whether the UL PRB usage metric meets a UL PRB usage metric threshold; and obtain uplink slot division based on the at least one ML model using a plurality of scheduling parameters associated with at least one UE. The plurality of scheduling parameters is determined based on the UL PRB usage metric meeting the UL PRB usage metric threshold.

For example, the plurality of scheduling parameters include at least one of the BO of each radio bearer from the list of radio bearers, a modulation and coding scheme (MCS) for each UE of the plurality of UEs, bandwidth part size of the (BWP) for each UE of the plurality of UE, a minimum symbol length after physical uplink shared channel (PUSCH) symbols have been classified into specific parts for each UE of the plurality of UEs, a uplink layer count for each UE of the plurality of UEs, BO size of each radio bearer from list of radio bearers, frequency of serving beam of each radio bearer from a list of radio bearers, or a multi-label encoded multi user-multiple input multiple output (MU-MIMO) pairing data of the radio bearers.

For example, the instructions, when execute by the at least one processor, cause the network apparatus to receive a buffer status report by each UE, wherein the buffer status report includes amount of data available at each radio bearer of the list of radio bearer associated with the corresponding UE for uplink transmission; and determine the BO of each radio bearer of the list of radio bearers associated with the plurality of UEs based on the received buffer status report.

For example, the instructions, when execute by the at least one processor, cause the network apparatus to determine a plurality of BO thresholds for each radio bearer of the list of radio bearers associated with plurality of UE based on a plurality of scheduling parameters and transmission capability of each UE; and group each of the radio bearers of the list of radio bearers associated with plurality of UE by comparing a BO of each of the radio bearer of list of radio bearers with BO thresholds for a corresponding bearer of the list of radio bearers associated with the plurality of UEs.

For example, the information on the number of divisions is determined based on a buffer occupancy of a radio bearer and a smallest BO threshold using at least one scheduling parameter of a UE corresponding to the radio bearer.

For example, a number of divisions for the radio bearer is determined such that a BO threshold in case of the number of divisions for the radio bearer is smallest in a set of BO thresholds that are greater than the buffer occupancy of the radio bearer.

In embodiments, a non-transitory computer readable storage medium storing instructions that, when executed by at least one processor, cause a network apparatus to obtain a list of radio bearers associated with plurality of user equipments (UEs); classify the list of radio bearers into a plurality of radio bearer groups based on information on a number of divisions possible in an uplink slot, for each radio bearer of the list of radio bearers associated with the plurality of UEs; identify a radio bearer group from the plurality of radio bearer groups based on a radio bearer having a highest priority and the information on the number of divisions for each radio bearer; and perform resource allocation for at least one UE associated with the identified radio bearer group.

For example, the instructions, when executed by the at least one processor, cause the network apparatus cause to identify, among the plurality of radio bearer groups, at least one radio bearer group, each radio bearer group of the selected at least one radio bearer group, wherein the highest priority indicates a maximum buffer occupancy (BO); and identify, among the at least one identified radio bearer group, the radio bearer group having a lowest number of divisions possible in a slot.

For example, the information on the number of divisions is determined based on a buffer occupancy of a radio bearer and a smallest BO threshold using at least one scheduling parameter of a UE corresponding to the radio bearer.

For example, a number of divisions for the radio bearer is determined such that a BO threshold in case of the number of divisions for the radio bearer is smallest in a set of BO thresholds that are greater than the buffer occupancy of the radio bearer.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method performed by a network apparatus, the method comprising:
obtaining a list of radio bearers associated with plurality of user equipments (UEs);
classifying the list of radio bearers into a plurality of radio bearer groups based on information on a number of divisions possible in an uplink slot, for each radio bearer of the list of radio bearers associated with the plurality of UEs;
identifying a radio bearer group from the plurality of radio bearer groups based on a radio bearer having a highest priority and the information on the number of divisions for each radio bearer; and
performing resource allocation for at least one UE associated with the identified radio bearer group.

2. The method of claim 1, wherein the identifying of the radio bearer group comprises:
identifying, among the plurality of radio bearer groups, at least one radio bearer group, each radio bearer group of the selected at least one radio bearer group, wherein the highest priority indicates a maximum buffer occupancy (BO); and
identifying, among the at least one identified radio bearer group, the radio bearer group having a lowest number of divisions possible in a slot.

3. The method of claim 1, wherein the performing of the resource allocation comprises:
determining an uplink physical resource block (UL PRB) usage metric for at least one machine learning (ML) model;
determining whether the UL PRB usage metric meets a UL PRB usage metric threshold; and
obtaining uplink slot division based on the at least one ML model using a plurality of scheduling parameters associated with at least one UE,
wherein the plurality of scheduling parameters is determined based on the UL PRB usage metric meeting the UL PRB usage metric threshold.

4. The method of claim 3, wherein the plurality of scheduling parameters include at least one of the BO of each radio bearer from the list of radio bearers, a modulation and coding scheme (MCS) for each UE of the plurality of UEs, bandwidth part size of the (BWP) for each UE of the plurality of UE, a minimum symbol length after physical uplink shared channel (PUSCH) symbols have been classified into specific parts for each UE of the plurality of UEs, a uplink layer count for each UE of the plurality of UEs, BO size of each radio bearer from list of radio bearers, frequency of serving beam of each radio bearer from a list of radio bearers, or a multi-label encoded multi user-multiple input multiple output (MU-MIMO) pairing data of the radio bearers.

5. The method of claim 1, wherein determining the BO of each radio bearer of the list of radio bearers associated with the plurality of UEs comprises:
receiving a buffer status report by each UE, wherein the buffer status report includes amount of data available at each radio bearer of the list of radio bearer associated with the corresponding UE for uplink transmission; and
determining the BO of each radio bearer of the list of radio bearers associated with the plurality of UEs based on the received buffer status report.

6. The method of claim 1, wherein classifying the list of radio bearers into the plurality of radio bearer groups comprises:
determining a plurality of BO thresholds for each radio bearer of the list of radio bearers associated with plurality of UE based on a plurality of scheduling parameters and transmission capability of each UE; and
grouping each of the radio bearers of the list of radio bearers associated with plurality of UE by comparing a BO of each of the radio bearer of list of radio bearers with BO thresholds for a corresponding bearer of the list of radio bearers associated with the plurality of UEs.

7. The method of claim 1, wherein the information on the number of divisions is determined based on a buffer occupancy of a radio bearer and a smallest BO threshold using at least one scheduling parameter of a UE corresponding to the radio bearer.

8. The method of claim 7, wherein a number of divisions for the radio bearer is determined such that a BO threshold in case of the number of divisions for the radio bearer is smallest in a set of BO thresholds that are greater than the buffer occupancy of the radio bearer.

9. A network apparatus comprising:
at least one processor, comprising processing circuitry; and
memory storing instructions that, when executed by the at least one processor, causes the network apparatus to:
obtain a list of radio bearers associated with plurality of user equipments (UEs);
classify the list of radio bearers into a plurality of radio bearer groups based on information on a number of divisions possible in an uplink slot, for each radio bearer of the list of radio bearers associated with the plurality of UEs;
identify a radio bearer group from the plurality of radio bearer groups based on a radio bearer having a highest priority and the information on the number of divisions for each radio bearer; and
perform resource allocation for at least one UE associated with the identified radio bearer group.

10. The network apparatus of claim 9, wherein the instructions, when execute by the at least one processor, cause the network apparatus to:
identify, among the plurality of radio bearer groups, at least one radio bearer group, each radio bearer group of the selected at least one radio bearer group, wherein the highest priority indicates a maximum buffer occupancy (BO); and
identify, among the at least one identified radio bearer group, the radio bearer group having a lowest number of divisions possible in a slot.

11. The network apparatus of claim 9, wherein the instructions, when execute by the at least one processor, cause the network apparatus to:
determine an uplink physical resource block (UL PRB) usage metric for at least one machine learning (ML) model;
determine whether the UL PRB usage metric meets a UL PRB usage metric threshold; and
obtain uplink slot division based on the at least one ML model using a plurality of scheduling parameters associated with at least one UE,
wherein the plurality of scheduling parameters is determined based on the UL PRB usage metric meeting the UL PRB usage metric threshold.

12. The network apparatus of claim 11, wherein the plurality of scheduling parameters include at least one of the BO of each radio bearer from the list of radio bearers, a modulation and coding scheme (MCS) for each UE of the plurality of UEs, bandwidth part size of the (BWP) for each UE of the plurality of UE, a minimum symbol length after physical uplink shared channel (PUSCH) symbols have been classified into specific parts for each UE of the plurality of UEs, a uplink layer count for each UE of the plurality of UEs, BO size of each radio bearer from list of radio bearers, frequency of serving beam of each radio bearer from a list of radio bearers, or a multi-label encoded multi user-multiple input multiple output (MU-MIMO) pairing data of the radio bearers.

13. The network apparatus of claim 9, wherein the instructions, when execute by the at least one processor, cause the network apparatus to:
receive a buffer status report by each UE, wherein the buffer status report includes amount of data available at each radio bearer of the list of radio bearer associated with the corresponding UE for uplink transmission; and
determine the BO of each radio bearer of the list of radio bearers associated with the plurality of UEs based on the received buffer status report.

14. The network apparatus of claim 9, wherein the instructions, when execute by the at least one processor, cause the network apparatus to:
determine a plurality of BO thresholds for each radio bearer of the list of radio bearers associated with plurality of UE based on a plurality of scheduling parameters and transmission capability of each UE; and
group each of the radio bearers of the list of radio bearers associated with plurality of UE by comparing a BO of each of the radio bearer of list of radio bearers with BO thresholds for a corresponding bearer of the list of radio bearers associated with the plurality of UEs.

15. The network apparatus of claim 9, wherein the information on the number of divisions is determined based on a buffer occupancy of a radio bearer and a smallest BO threshold using at least one scheduling parameter of a UE corresponding to the radio bearer.

16. The network apparatus of claim 9, wherein a number of divisions for the radio bearer is determined such that a BO threshold in case of the number of divisions for the radio bearer is smallest in a set of BO thresholds that are greater than the buffer occupancy of the radio bearer.

17. A non-transitory computer readable storage medium storing instructions that, when executed by at least one processor, cause a network apparatus to:
obtain a list of radio bearers associated with plurality of user equipments (UEs);
classify the list of radio bearers into a plurality of radio bearer groups based on information on a number of divisions possible in an uplink slot, for each radio bearer of the list of radio bearers associated with the plurality of UEs;
identify a radio bearer group from the plurality of radio bearer groups based on a radio bearer having a highest priority and the information on the number of divisions for each radio bearer; and
perform resource allocation for at least one UE associated with the identified radio bearer group.

18. The transitory computer readable storage medium of claim 17, wherein the instructions, when executed by the at least one processor, cause the network apparatus cause to:
identify, among the plurality of radio bearer groups, at least one radio bearer group, each radio bearer group of the selected at least one radio bearer group, wherein the highest priority indicates a maximum buffer occupancy (BO); and
identify, among the at least one identified radio bearer group, the radio bearer group having a lowest number of divisions possible in a slot.

19. The transitory computer readable storage medium of claim 17, wherein the information on the number of divisions is determined based on a buffer occupancy of a radio bearer and a smallest BO threshold using at least one scheduling parameter of a UE corresponding to the radio bearer.

20. The transitory computer readable storage medium of claim 17, wherein a number of divisions for the radio bearer is determined such that a BO threshold in case of the number of divisions for the radio bearer is smallest in a set of BO thresholds that are greater than the buffer occupancy of the radio bearer.
